(19) United States
(12) Patent Application Publication
(10) Pub. No.: US 2013/0092775 A1
(43) Pub. Date: Apr. 18, 2013

(54) MULTI-CUTTER AND MULTI-SPINDLE FRUIT AND VEGETABLE STIRRER

(71) Applicant: Wenxiong WANG, Huangmei (CN)

(72) Inventor: Wenxiong WANG, Huangmei (CN)

(21) Appl. No.: 13/275,763

(22) Filed: Oct. 18, 2011

(51) Int. Cl. B02C 17/20

(52) U.S. Cl. 241/277

(57) ABSTRACT

The present invention relates to a device for triturating and stirring fruits and vegetables, and breaking ice, and in particular to the stirring cutter transmission structure within the device. It comprises a motor. at least three stirring cutter sets, and at least three stirring cutter set driving shafts, each of the stirring cutter set is connected with a driving shaft, the stirring cutter set is a four-blade stirring cutter set, the motor is connected with a driving wheel, each of the driving shaft is mounted thereon with a driven wheel, the motor drives the driving wheel to drive the driven wheel which causes each stirring cutter set to rotate.

### BACKGROUND OF THE INVENTION

1. Field of the Invention

The present disclosure is related to a device for triturating and squeezing fruits, vegetables, and legume, and in particular to the stirring cutter transmission structure within the device.

2. Description of Related Art

A stirrer is used for triturating fruits and squeezing juice therefrom. The prior art stirrer is of a single-spindle and single-cutter structure, which drives a piece of stirring cutter through an electric motor for triturating fruits within a juice container. However, the single-spindle and single-cutter structure causes the object to be stirred rotate in the rotating direction of the cutter due to the force generated at high speed of rotation, thus the object to be stirred is put into a synchronous movement with respect to the rotating cutter, so the effect and efficiency of triturating, stirring, and squeezing is greatly reduced. In the foreign markets there appears a kind of stirrer with two stirring cutters. However, since the shape of a container is mostly of a circular or regular shape, the stirring contour generated by the two stirring cutters does not comply with the spatial shape within the container, and there are more dead zones during stirring, so the stirring effect thereof is often not so good as that of the a single stirring cutter.

### BRIEF SUMMARY OF THE INVENTION

One of the objects of the present invention is to provide a stirring cutter transmission structure for a stirrer with which the juice of fruits or vegetables may be finely prepared and the time required for stirring is short.

To achieve the above object or some other objects, the present invention adopts the following technical solution.

It comprises a motor, at least three stirring cutter sets, and at least three stirring cutter set driving shafts, each of the stirring cutter is connected with a driving shaft, the motor is connected with a driving wheel, each of the driving shaft is mounted thereon with a driven wheel is mounted, the motor drives the driving wheel to drive the driven wheel which causes each stirring cutter set to rotate.

Preferably, the stirring cutter comprises a steel ring lap part and a driven wheel lap part, the steel ring lap part is provided in a steel ring and the driven wheel lap part is exposed from the steel ring lap part at the lower end thereof, the steel ring is mounted therein with an upper sealing ring and a lower sealing ring, the driven wheel lap part penetrates through the driven wheel, the driven wheel is respectively mounted at the upper portion and the lower portion thereof with an upper bearing and a lower bearing, a cutter seat is provided thereon with a fixing shaft corresponding to the stirring cutter, the fixing shaft is provided in the center thereof with a hole, the bottom portion of the driven wheel lap part of the cutter seat is provided in the fixing shaft and is rotated in the hole under the driving of the driven wheel.

Preferably, between the driven wheel and the upper bearing and lower bearing, there are respectively mounted an upper bakelite spacer and a lower bakelite spacer.

Preferably, between the upper bakelite spacer and the upper bearing, there is mounted a plastic spacer.

Preferably, between the motor and the driving wheel, there is provided a clutch structure.

Preferably, the clutch structure comprises a connector provided above the motor and a clutch provided on the connector, the connector comprises a base plate, on the base plate there is provided a circular accommodating space, the circular accommodating space is equally divided into six parts, and in the center of the base plate and the accommodating space being equally divided into six parts, there is provided an axle hole; the clutch comprises a circular top plate, on the circumference of the circular top plate, there are evenly distributed six triangles vertically extending downwardly, the six triangles cooperate with six equally-divided parts of the accommodating space.

Preferably, the motor is connected with the driving wheel through a mainshaft, and the mainshaft is divided into an upper driving wheel connecting part and a lower clutch connecting part.

Preferably, the stirring cutter set comprises three stirring cutters evenly distributed on the circumference.

Preferably, the stirring cutter set is a four-blade stirring cutter set.

By providing two or more stirring cutters according to the stirring cutter transmission structure of the stirrer of the present invention, upon stirring of fruits, there are many acting points of the stirring cutter which is stirring within the juice container, and the areas of action are dispersed, so that uniform stirring of fruits and vegetables may be achieved, and the scraps of the fruits and vegetables may be stirred throughout the juice container. With the design of multi-spindle and multi-cutter and crossing interflow, the effect and efficiency of triturating, stirring, and squeezing is increased above 3-5 times over the traditional design.

The above-described and other features and advantages of the present disclosure will be appreciated and understood by those skilled in the art from the following detailed description, drawings, and appended claims.

### BRIEF DESCRIPTION OF THE SEVERAL VIEWS OF THE DRAWINGS

FIG. 1 is a schematic view of the mounting structure of an embodiment of the present invention;

FIG. 2 is a partially exploded view of the multi-spindle portion of an embodiment of the present invention;

FIG. 3 is a schematic view of the structure of the connector of an embodiment of the present invention;

FIG. 4 is a schematic view of the structure of the clutch of the embodiment of the present invention.

In connection with the embodiments, the objects, functions and advantages of the present invention will be further explained with reference to the drawings.

### DETAILED DESCRIPTION OF THE INVENTION

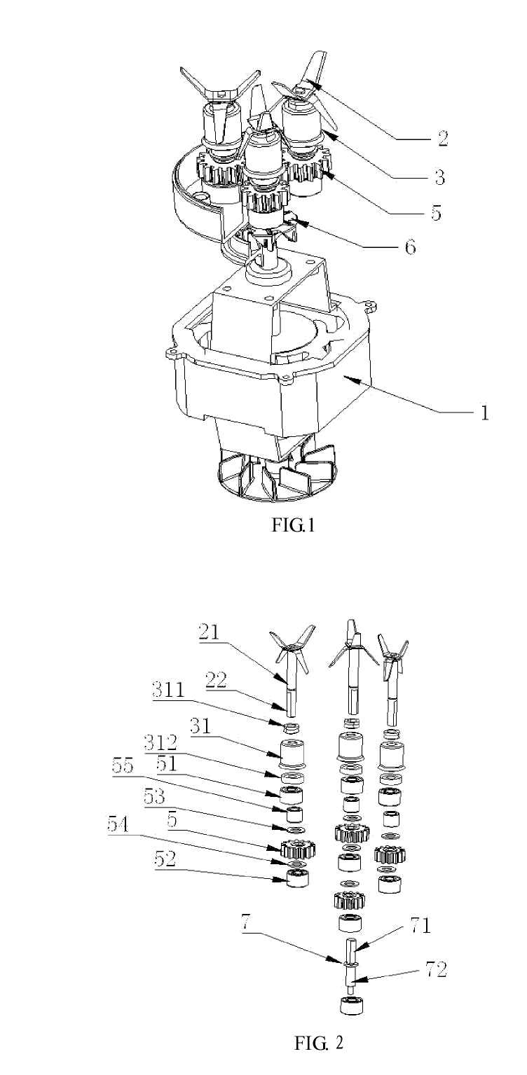

As shown in FIGS. 1 and 2, the stirring cutter set transmission structure of the stirrer according to this embodiment comprises a motor 1; at least three stirring cutter sets 2, each of which is connected with a driving shaft 3, the motor 1 is connected with a driving wheel 4 (which is not shown in the figure for the sake of viewing angle, see the figure), each of the driving shaft 3 is mounted thereon with a driven wheel 5, the motor 1 drives the driving wheel 4 to drive the driven wheel 4 which causes each stirring cutter 2 to rotate.

The stirring cutter set 2 of the present embodiment comprises a steel ring lap part 21 and a driven wheel lap part 22. The driving shaft 3 comprises a steel ring 31. The steel ring lap part 21 is provided in the steel ring 31 and the driven wheel lap part 22 is exposed from the steel ring lap part 21 at the lower end thereof. The steel ring 31 is mounted therein with an upper sealing ring 311 and a lower sealing ring 312. The upper sealing ring 311 and the lower sealing ring 312 seal the liquid substance within the stirring cup of the stirrer to prevent water leakage. The driven wheel lap part 22 penetrates through the driven wheel 5, and the driven wheel 5 is respectively mounted at the upper portion and the lower portion thereof with an upper bearing 51 and a lower bearing 52.

In the present embodiment, between the driven wheel 5 and the upper bearing 51 and lower bearing 52, there are respectively mounted an upper bakelite spacer 53 and a lower bakelite spacer 54.

Between the upper bakelite spacer 53 and the upper bearing 51, there is mounted a plastic spacer 55. The bakelite spacer 53 is for anti-abrasion and the plastic spacer mainly functions to increasing the height.

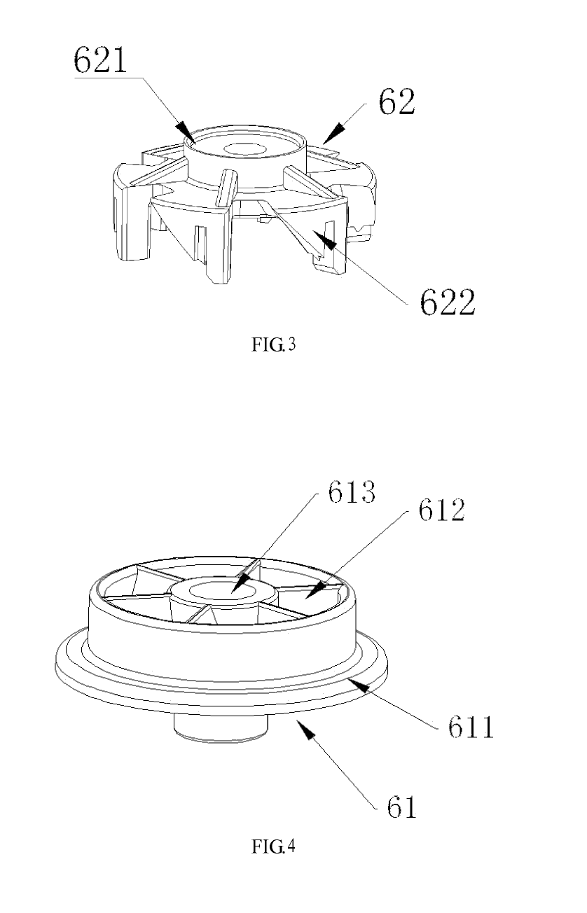

As shown in FIGS. 1, 3 and 4, between the motor 1 and the driving wheel 4, there is provided a clutch structure 6. The motor is connected with a mainshaft 7, and the mainshaft 7 is divided into an upper driving wheel connecting part 71 and a lower clutch connecting part 72.

The clutch structure 6 comprises a connector 61 provided above the motor 1 and a clutch 62 provided on the connector 61. The connector 61 comprises a base plate 611, on which there is provided a circular accommodating space 612. The circular accommodating space 612 is equally divided into six parts, and in the center of the base plate and the accommodating space being equally divided into six parts, there is provided an axle hole 613. The clutch 62 comprises a circular top plate 621, on the circumference of which there are evenly distributed six triangles 622 vertically extending downwardly. The six triangles 622 cooperate with the six equally-divided parts of the accommodating space 612. The clutch is mainly for integrally connecting the stirring cutter sets and the motor. When the motor is rotating, the force is transmitted to a sun wheel through the clutch, and the sun wheel engages with the planetary wheel, so as to drive the stirring cutter sets to perform the operation of stirring.

In the present embodiment, three stirring cutter sets 2 are evenly distributed on the circumference, and the stirring cutter set is a four-blade stirring cutter set.

The above is merely a preferred embodiment of the present invention and is not aimed to limit the scope of the present invention. Any equivalent modification regarding the structure or the process flow on the basis of present description and drawings, whether with direct or indirect application to other relevant technical fields, are considered to fall within the scope of protection of the present invention.

What is claimed is:

1. A multi-cutter and multi-spindle fruit and vegetable stirrer, wherein it comprises a motor, at least three stirring cutter sets, and at least three stirring cutter set driving shafts, each of said stirring cutter is connected with a driving shaft, said motor is connected with a driving wheel, each of said driving shaft is mounted thereon with a driven wheel, said motor drives the driving wheel to drive the driven wheel which causes each stirring cutter set to rotate.

2. The multi-cutter and multi-spindle fruit and vegetable stirrer according to claim 1, wherein said stirring cutter comprises a steel ring lap part and a driven wheel lap part, said steel ring lap part is provided in a steel ring and the driven wheel lap part is exposed from the steel ring lap part at the lower end thereof, said steel ring is mounted therein with an upper sealing ring and a lower sealing ring, said driven wheel lap part penetrates through the driven wheel, said driven wheel is respectively mounted at the upper portion and the lower portion thereof with an upper bearing and a lower bearing, a cutter seat is provided thereon with a fixing shaft corresponding to the stirring cutter, said fixing shaft is provided in the center thereof with a hole, the bottom portion of the driven wheel lap part of said cutter seat is provided in the fixing shaft and is rotated in the hole under the driving of the driven wheel.

3. The multi-cutter and multi-spindle fruit and vegetable stirrer according to claim 1, wherein between said driven wheel and the upper bearing and lower bearing, there are respectively mounted an upper bakelite spacer and a lower bakelite spacer.

4. The multi-cutter and multi-spindle fruit and vegetable stirrer according to claim 3, wherein between said upper bakelite spacer and said upper bearing, there is mounted a plastic spacer.

5. The multi-cutter and multi-spindle fruit and vegetable stirrer according to claim 1, wherein between said motor and the driving wheel, there is provided a clutch structure.

6. The multi-cutter and multi-spindle fruit and vegetable stirrer according to claim 5, wherein said clutch structure comprises a connector provided above the motor and a clutch provided on the connector, said connector comprises a base plate, on the base plate there is provided a circular accommodating space, said circular accommodating space is equally divided into six parts, and in the center of said base plate and the accommodating space being equally divided into six parts, there is provided an axle hole; said clutch comprises a circular top plate, on the circumference of said circular top plate, there are evenly distributed six triangles vertically extending downwardly, said six triangles cooperate with six equally-divided parts of the accommodating space.

7. The multi-cutter and multi-spindle fruit and vegetable stirrer according to claim 6, wherein said motor is connected with the driving wheel through a mainshaft, and said mainshaft is divided into an upper driving wheel connecting part and a lower clutch connecting part.

8. The multi-cutter and multi-spindle fruit and vegetable stirrer according to claim 7, wherein said stirring cutter set comprises three stirring cutters evenly distributed on the circumference.

9. The multi-cutter and multi-spindle fruit and vegetable stirrer according to claim 8, wherein said stirring cutter set is a four-blade stirring cutter set.
